(19) United States
(12) Patent Application Publication
(10) Pub. No.: US 2005/0254453 A1
(43) Pub. Date: Nov. 17, 2005

(54) Priority session management system and method for a mobile communication device

(75) Inventor: Ayelet Barneah, Tel-Aviv (IL)

Correspondence Address: FARSHAD JASON FARHADIAN;CENTURY IP LAW GROUP, P.O. BOX 7333, NEWPORT BEACH, CA, 92658-7333, US

(73) Assignee: Mobile (R&D) Ltd.

(21) Appl. No.: 10/846,186

(22) Filed: May 13, 2004

(51) Int. Cl. H04Q 7/00

(52) U.S. Cl. 370/328

(57) ABSTRACT

A system for prioritizing communication sessions between a mobile device and a plurality of secondary devices is provided. The system comprises a mechanism for monitoring connections between the mobile device and the plurality of secondary devices to determine user preference; and a mechanism for establishing a communication session between the mobile device and a first secondary device from among said plurality of secondary devices to perform a first function, wherein the first secondary device is connected to the mobile device and a first priority is associated with the first secondary device to perform the first function.

### BACKGROUND

1. Field of Invention

The present invention relates generally to mobile communication services and, more particularly, to a system and method for managing communication sessions between a mobile communication device and network devices connected to it in a short-range communication network.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Mobile devices such as cellular phones and personal digital assistants (PDAs) can be equipped with wired or wireless communication ports to connect and communicate with other devices. Some devices, such as conventional earpieces, or hands-free speaker systems may connect to the mobile device by way of cable through pin or switch enabled ports. More advanced peripheral devices equipped with wireless ports with infrared or radio frequency operated interfaces (e.g., Bluetooth) allow the mobile device to connect and communicate with peripheral or secondary wireless devices in a short-range communication network.

Accordingly, wired and wireless interfaces can be utilized to accommodate the establishment of a connection or communication session between the mobile device and one or more peripheral devices. For example, a mobile device may use a cable to connect to a microphone/speaker headset, or establish a wireless communication session with a hands-free speaker system over a Bluetooth connection.

As such, some users may configure a number of peripheral devices to communicate with the communication ports of the mobile device in either a wired or wireless environment. Since, a user may for example utilize both a headset and a hands-free system, and perhaps other peripheral devices connected to the mobile device at the same time, there is a chance for operational interference.

That is, if the connected devices are configured to systematically perform the same or similar functions (e.g., input/output audio) then it is likely that either only one of the devices will randomly perform the function or that all the devices will perform the same function at the same time. Obviously, neither of the two mentioned scenarios is desirable.

It would be preferable for the user to control the communication sessions between the mobile device and the peripherals in accordance to a preconfigured priority. For example, a user may want to automatically direct voice communication received by his mobile phone to (1) a head set when he is at home, (2) to a hands-free speaker when he enters his vehicle, (3) and to a peripheral computing system such as a desktop computer, when he is in his office.

Unfortunately, none of the currently available systems address the above-mentioned need. Thus, improved interface systems and operating environments are needed that can overcome the above shortcomings.

### SUMMARY

The present invention is directed to a system and corresponding methods that facilitate prioritizing establishing communication sessions between a mobile device and one or more peripheral devices connected to it in accordance with user preference.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for prioritizing communication sessions between a mobile device and a plurality of peripheral devices is provided. The method comprises monitoring connections between the mobile device and the plurality of peripheral devices to determine user preference; and establishing a communication session between the mobile device and a first peripheral device from among said plurality of peripheral devices to perform a first function, wherein the first peripheral device is connected to the mobile device and a first priority is associated with the first peripheral device to perform the first function.

The method further comprises assigning a plurality of priorities to the plurality of peripheral devices with respect to the first function. The first priority associated with the first peripheral device is higher than priorities associated with other peripheral devices connected to the mobile device with respect to the first function. The plurality of priorities is associated to the plurality of the peripheral devices based on user preference.

The user preference is determined based on monitoring the connections established between the mobile device and the plurality of peripheral devices for performing the first function. The user preference may be also determined based on the user interacting with a user interface menu of the mobile device. In one embodiment, the mobile device is a cellular telephone.

In accordance with one embodiment, the communication session between the mobile device and a second peripheral device performing the first function is terminated, when the communication session is established between the mobile device and the first peripheral device. A communication session is established between the mobile device and a second peripheral device from among said plurality of peripheral devices to perform a second function, wherein the second peripheral device is connected to the mobile device and a priority is associated with the second peripheral device to perform the second function.

The first priority to perform the first function is associated with a second peripheral device, when the step of monitoring connections between the mobile device and the plurality of peripheral devices indicates that the user preference has changed, to prefer the second peripheral device over the first peripheral device to perform the first function.

In accordance with yet another embodiment, a system for prioritizing communication sessions between a mobile device and a plurality of secondary devices is provided. The system comprises a mechanism for monitoring connections between the mobile device and the plurality of secondary devices to determine user preference; and a mechanism for establishing a communication session between the mobile device and a first secondary device from among said plurality of secondary devices to perform a first function, wherein the first secondary device is connected to the mobile device and a first priority is associated with the first secondary device to perform the first function.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of a method for establishing communication sessions between a mobile device and one or more secondary devices connected to it in accordance with user preference; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for establishing communication sessions between a mobile device and one or more peripheral devices connected to it in accordance with user preference.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

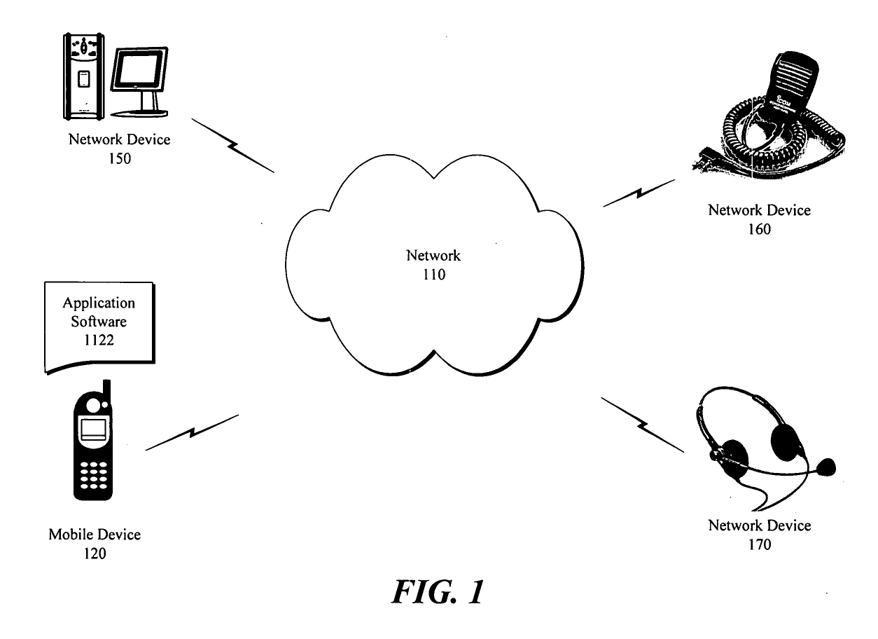

Referring to the drawings, FIG. 1 illustrates an exemplary communication environment in which the system of the present invention may operate. In accordance with one aspect of the system, the system environment comprises a mobile device 120 that can communicate with one or more network devices 150-170 connected to it in a wired environment, a wireless network 110, or both. The terms “connected,” “coupled,” or any variant thereof, mean any connection or coupling, either direct or indirect, between two or more elements. The coupling or connection between the elements can be physical, logical, or a combination thereof.

In one embodiment, one or more network devices 150-170 communicate with the mobile device 120 via communication network 110. The communication network 110 provides the medium and infrastructure for transmitting digital or analog signals between network devices 150-170 and mobile device 120. For the purpose of uniformity, throughout this disclosure, the terms network device and network devices are used to define one or more independent, peripheral, or secondary devices connected to mobile device 120, whether or not the connection is established in a networked or non-networked environment.

Referring to FIG. 1, a network device may be a stand-alone computing device (e.g., network device 150), a mobile communication device (e.g., network device 160), a peripheral device (e.g., network device 170), or other device that can establish a connection with mobile device 120. In certain embodiments, mobile device 120 is a cellular telephone and communication network 110 is a short-range wireless network (e.g., a personal area network (PAN)) implemented over a wireless communication protocol such as Bluetooth or IEEE 802.11. Network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communication network.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with network devices 150-170 to send and receive electronic packets of information, in form of electronic requests and responses over network 110. As used herein, the terms mobile device, network device, and communication network are to be viewed as designations of one or more computing environments that comprise application, client or server software for servicing requests submitted by respective software included in devices or other computing systems connected there to. These terms are not to be otherwise limiting in any manner. The application software, for example, may be comprised of one or more modules that execute on one or more computing systems, as described in further detail below.

In accordance with one aspect of the invention, application software 1122 is implemented, installed, or executed on mobile device 120 to determine if a preferred network device is connected to mobile device 120. If so then a session is established between mobile device 120 and the preferred network device. If the preferred network device is not connected, then application software 1122 determines if another device is connected to mobile device 120 and then a session is established between the mobile device 120 and the other device.

It should be noted that the above exemplary embodiment is not to be construed to limit the scope of the invention to application software 1122 that executes exclusively on the mobile device 120, or to a networked environment. As noted above, application software 1122 may be implemented on a device or a system other than mobile device 120. For example, application software 1122 or its components may be implemented, installed, and executed either in a singular or in a distributed environment. That is, certain components of the application software may be installed and executed on mobile device 120, while other components may be executed and installed on a third party portal, network devices 150-170, or other systems attached thereto.

The method of this invention, in addition to network devices 150-170, may be also applied to integrated components of mobile device 120. Thus, for example, if a preferred device is not attached to mobile device 120 to perform a certain function, then the function will be delegated to an internal component of mobile device 120. For example, a user preference may be for an incoming voice communication received by mobile device 120 to be outputted via a hands-free speaker system (e.g., network device 160). If, however, the hands-free speaker is not attached, then the voice communication may be directed for output to the internal speaker of mobile device 120, for example.

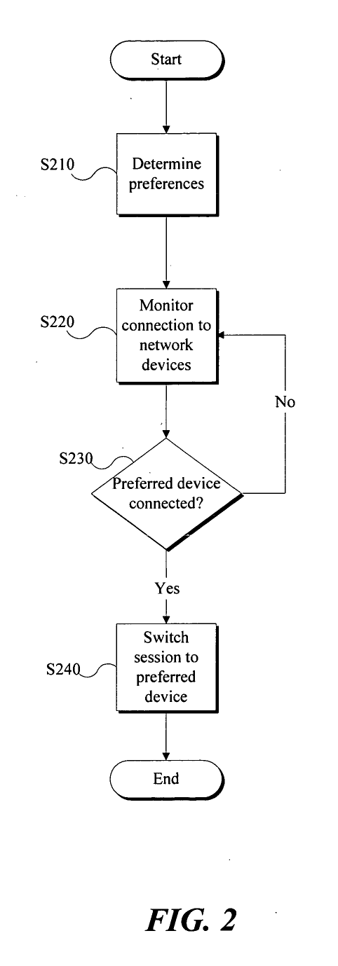

Referring to FIGS. 1 and 2, in accordance with one aspect of the invention, application software 1122 or a component thereof is executed on mobile device 120 to monitor user interaction with mobile device 120 and other network devices to determine user preferences (S210). Application software 1122, in one embodiment, is configured to provide a user with an interactive menu that provides the user with options to select one or more of network devices 150-170 as a default device to perform one or more functions.

For example, a user menu may allow the user to select network device 150 (e.g., a desktop computer) as the primary device for receiving email messages forwarded to mobile device 120. In a preferred embodiment, the user menu may also allow the user to select a backup device (e.g., a PDA) for receiving email message forwarded to mobile device 120, if network device 150 is not available. In alternative embodiments, the user may select more than two devices to perform each function, and assign a priority to each device, based on user preference.

In a preferred embodiment, application software 1122 may automatically determine the user preference by monitoring user interaction with mobile device 120 and the related devices. For example, statistical records may be kept by application software 1122 about the number, frequency, and the intervals in which a user uses mobile device 120 to interact with or connect to network devices 150-170. For each function, application software 1122 determines the user preference by analyzing the statistical information gathered.

For example, a mobile device 120 may be initially configured to connect to a network device 150 (e.g., desktop computer), a network device 160 (a hands-free speaker system), and a network device 170 (e.g., a head set) in no particular order. Application software 1122 tracks the number of times mobile device 120 establishes a connection with each device, the duration of each connection and the purpose of each connection. Thus, if statistical data gathered for the various devices shows that a user prefers to use network device 160 (e.g., the hands-free speaker system) more often than the network device 150 and 170, when the user receives a voice call, then application software 1122 assigns network device 160 as the primary device to be activated when a voice call is received.

One skilled in the pertinent art would appreciate that the above statistical approach may be applied to determine a second, third, or any number of alternative preferences for a combination of devices and functions connected to mobile device 120. Regardless of whether application software 1122 is configured manually or automatically to determine user preferences, once the preferences are determined, then application software continues to monitor mobile device 120's connection status to each network device (S220). By monitoring the connection status for each device, application software 1122 can determine if a preferred device is available to perform a certain operation when the need arises.

As such, in accordance with one embodiment of the invention, a priority list (e.g., a logical data structure) is instantiated by application software 1122 to record and track user preferences with respect to one or more functions performed by mobile device 120. Thus, application software 1122 may determine the user's preferred device for performing a function in accordance with the following exemplary Table:

TABLE 1

| FUNCTION/ | Voice Communication | Text Messages | |
|---|---|---|---|
| PREFERENCE | (Function 1) | (Function 2) | . . . |
| First Preference | Hands-free Speaker | Desktop | . . . |
| Second Preference | Head Set | PDA | . . . |
| Third Preference | Desktop | Mobile Device | . . . |
| . . . | . . . | . . . | . . . |

Referring to Table 1, for a voice communication function, the order of device preferences may include a hands-free speaker, a headset, and a desktop; and for a text messaging function, the order of preferences may include a desktop, a PDA, and a mobile device, for example.

Referring back to FIGS. 1 and 2, in the above example, if mobile device 120 receives a voice call, application software 1122 determines whether the primary preferred device, network device 160 (e.g., hands-free speaker) is connected to mobile device 120 (S230). If so, then application software 1122 establishes a session between mobile device 120 and the primary preferred device (S240). Else, application software 1122 continues to monitor new or established connections between mobile device 120 and network device 150-170 either in real-time or based on the instantiated priority list above, to find a preferred network device to perform the respective function.

According to Table 1, for example, if network device 160 (e.g., a hands-free speaker) is not connected to mobile device 120, then it is determined if network device 170 (e.g., a head set) is connected to mobile device 120. If so, a communication session is established between mobile device 120 and network device 170, for example. Else, a communication session is established with network device 150 (e.g., a desktop) if available, and the voice call is forwarded to network device 150.

Certain embodiments of the invention are implemented such that the user can choose to configure application software 1122 to automatically switch a communication session established between mobile device 120 and a device with a lower priority to a device with a higher priority, once the higher priority device is connected to mobile device 120. That is, application software 1122 may be configured to terminate a session with a lower priority device (e.g., head set) in favor of establishing a new session with a higher priority device (e.g., hands-free speaker), when the higher priority device is connected.

Thus, in the above exemplary embodiments, a session established between mobile device 120 and network device 170 (e.g., head set) may be terminated, when network device 160 (e.g., hands-free speaker) is connected to mobile device 120; and a new session may be established with network device 160 (e.g., hands-free speaker).

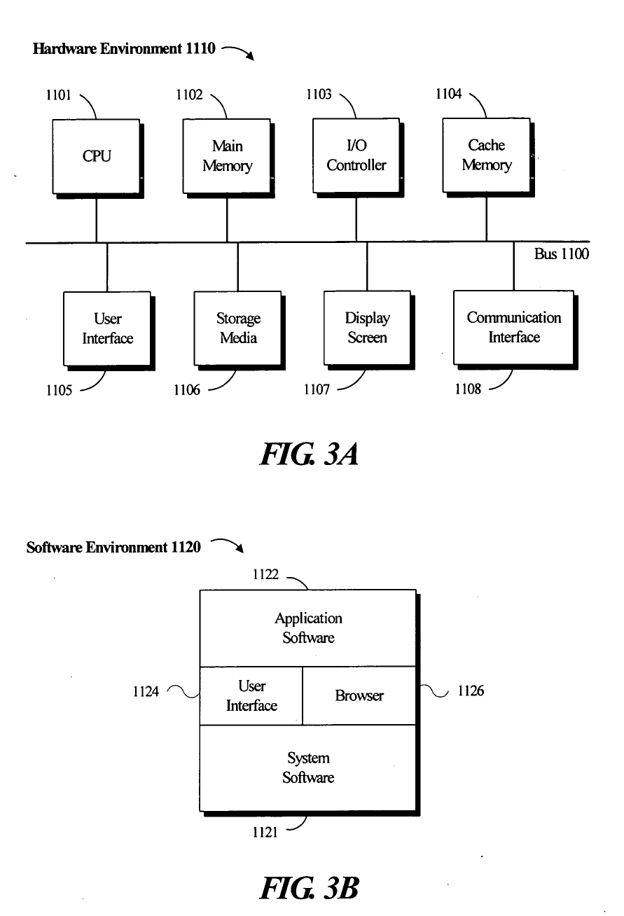

In embodiments of the system, network devices 150-170, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to accommodate the delayed transmission of messages addressed to mobile device 120 in accordance to the conditions set forth above.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock, not shown in FIG. 2A).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile unit 110 may be a PMG phone or equivalent.

In embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1 for example, in one embodiment of the invention, client software is executed on mobile device 120 and server software is executed on network devices 150-170.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate managing communication session established between mobile device 120 and one or more secondary devices. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of prioritizing communication sessions between a mobile device and a plurality of peripheral devices, the method comprising:
monitoring connections between the mobile device and the plurality of peripheral devices to determine user preference; and
establishing a communication session between the mobile device and a first peripheral device from among said plurality of peripheral devices to perform a first function,
wherein the first peripheral device is connected to the mobile device and a first priority is associated with the first peripheral device to perform the first function.

2. The method of claim 1, further comprising:
assigning a plurality of priorities to the plurality of peripheral devices with respect to the first function.

3. The method of claim 2, wherein the first priority associated with the first peripheral device is higher than priorities associated with other peripheral devices connected to the mobile device with respect to the first function.

4. The method of claim 3, further comprising associating the plurality of priorities to the plurality of the peripheral devices based on user preference.

5. The method of claim 4, further comprising determining the user preference based on monitoring the connections established between the mobile device and the plurality of peripheral devices for performing the first function.

6. The method of claim 4, further comprising determining the user preference based on the user interacting with a user interface menu of the mobile device.

7. The method of claim 1, wherein the mobile device is a cellular telephone.

8. The method of claim 1, further comprising:
terminating a communication session between the mobile device and a second peripheral device performing the first function, when the communication session is established between the mobile device and the first peripheral device.

9. The method of claim 1, further comprising:
establishing a communication session between the mobile device and a second peripheral device from among said plurality of peripheral devices to perform a second function,
wherein the second peripheral device is connected to the mobile device and a priority is associated with the second peripheral device to perform the second function.

10. The method of claim 1, further comprising:
associating the first priority to perform the first function with a second peripheral device, when the step of monitoring connections between the mobile device and the plurality of peripheral devices indicates that the user preference has changed, to prefer the second peripheral device over the first peripheral device to perform the first function.

11. A system for prioritizing communication sessions between a mobile device and a plurality of secondary devices, the system comprising:
a mechanism for monitoring connections between the mobile device and the plurality of secondary devices to determine user preference; and
a mechanism for establishing a communication session between the mobile device and a first secondary device from among said plurality of secondary devices to perform a first function,
wherein the first secondary device is connected to the mobile device and a first priority is associated with the first secondary device to perform the first function.

12. The system of claim 11, further comprising:
a mechanism for assigning a plurality of priorities to the plurality of secondary devices with respect to the first function.

13. The system of claim 12, wherein the first priority associated with the first secondary device is higher than priorities associated with other secondary devices connected to the mobile device with respect to the first function.

14. The system of claim 13, further comprising a mechanism for associating the plurality of priorities to the plurality of the secondary devices based on user preference.

15. The system of claim 14, further comprising a mechanism for determining the user preference based on monitoring the connections established between the mobile device and the plurality of secondary devices for performing the first function.

16. The system of claim 14, further comprising a mechanism for determining the user preference based on the user interacting with a user interface menu of the mobile device.

17. The system of claim 11, wherein the mobile device is a cellular telephone.

18. The system of claim 11, further comprising:
a mechanism for terminating a communication session between the mobile device and a second secondary device performing the first function, when the communication session is established between the mobile device and the first secondary device.

19. The system of claim 11, further comprising:
a mechanism for establishing a communication session between the mobile device and a second secondary device from among said plurality of secondary devices to perform a second function,
wherein the second secondary device is connected to the mobile device and a priority is associated with the second secondary device to perform the second function.

20. The system of claim 11, further comprising:
a mechanism for associating the first priority to perform the first function with a second secondary device, when the step of monitoring connections between the mobile device and the plurality of secondary devices indicates that the user preference has changed, to prefer the second secondary device over the first secondary device to perform the first function.
